(19) United States
(12) Patent Application Publication
(10) Pub. No.: US 2011/0017000 A1
(43) Pub. Date: Jan. 27, 2011

(54) SLIDE APPARATUS FOR MOBILE COMMUNICATION TERMINAL

(76) Inventors: SungBin Kim, Gyeonggi-do (KR); Jong-Won Ha, Gyeongsangbuk-do (KR)

Correspondence Address: THE NATH LAW GROUP, 112 South West Street, Alexandria, VA, 22314, US

(21) Appl. No.: 12/444,658

(22) PCT Filed: Mar. 21, 2008
(86) PCT No.: PCT/KR2008/001621

§ 371 Date: Jan. 13, 2010

(30) Foreign Application Priority Data
Jul. 10, 2007 (KR) 10-2007-0069328

(51) Int. Cl. F16H 21/54

(52) U.S. Cl. 74/100.1

(57) ABSTRACT

Provided is a slide apparatus of a mobile communication terminal including: a first slide member fixed on a lower body of a mobile communication terminal; a second slide member that is fixed on an upper body of the mobile communication terminal and slideably coupled to the first slide member; and a torsion assembly providing torsion to the second slide member when the second slide member slides toward the first slide member, wherein the torsion assembly comprises: a first spring that is formed of a first coil that is wound in a circle and a first extension portion extending from a first end of the first coil, and is disposed between the first slide member and the second slide member, wherein an end of the first extension portion is coupled to the second slide member; a second spring that is formed of a second coil that is wound in a circle and stacked above or below the first coil and a second extension portion extending from a first end of the second coil, and is disposed between the first slide member and the second slide member, wherein an end of the second extension portion is coupled to the first slide member; and a coupling member coupling second ends of the first coil and the second coil.

### TECHNICAL FIELD

The present invention relates to a slide apparatus of a mobile communication terminal, and more particularly, to a slide apparatus of a mobile communication terminal which can be easily assembled and has excellent durability.

### BACKGROUND ART

A mobile communication terminal refers to a wireless communication terminal that a user can carry along with him or her and use to communicate with others while mobile. The mobile communication terminal can be classified into a flip type, a folder type, and a slide type, according to appearance or operation principle. Among these, a slide type mobile communication terminal is comprised of two slide parts which are disposed to overlap each other, wherein a display unit and key buttons are disposed in the same direction in each of the slide parts, as illustrated in FIG. 1. That is, a slide type mobile communication terminal includes an upper body 100 including a display unit 101, and a lower body 110 including key buttons 111. The lower body 110 is disposed below the upper body 100 and can be slid back and forth in the form of a slide apparatus.

In the slide apparatus, the upper body 100 and the lower body 110 are coupled to each other and the upper body 100 can be slid in a straight direction toward the lower body 110.

As shown in FIG. 2, the slide apparatus includes a first slide member 130 fixed on the lower body 110, a second slide member 140 that is fixed on the upper body 100 and is slideably coupled to the first slide member 130, and a torsion assembly 150 providing torsion to the second slide member 140 when the second slide member 140 is slid toward the first slide member 130. The torsion assembly 150 is formed of a pair of springs, and each of the springs is formed of a coil 151 wound in a circle and two extension portions 152 extended from both ends of the coil 151. An end of each of the extension portions 152 is rotatably coupled to the first slide member 130 and the second slide member 140.

FIGS. 3 and 4 illustrate the operation of the slide apparatus of FIG. 2. As the second slide member 140 is raised, the distance between the extension portions 152 of each of the springs is gradually decreased, and thus torsion provided to the second slide member 140 is increased. When the second slide member 140 reaches a middle line of the overall elevation height, the distance between the extension portions 152 is minimized and torsion provided to the second slide member 140 is maximized. In this state, by moving the second slide member 140 a little bit upward, via the torsion provided by the torsion assembly 150 (the force tending to broaden the distance between the extension portions), the second slide member 140 can be moved to its maximum without only a little external force.

However, the conventional slide apparatus has the following problems.

In the above-described slide apparatus, a pair of springs (two springs) are installed between the first slide member 130 and the second slide member 140, and this requires an increased assembly time compared to the assembly of one spring. Here, when one spring is used to reduce the assembly time, the torsion becomes weak and thus torsion cannot be provided properly.

Also, in order that identical torsion can be provided using one pair of springs, the position of the springs needs to be precisely adjusted. However, this adjustment is not easy, and moreover, even when identical torsion is provided to each of the springs by adjusting the position of the springs, it is difficult to maintain the torsion over an extended period of time. As such, when no identical torsion is provided from the torsion springs, sliding reliability of the whole mobile communication terminal is decreased. Also, force is disproportionately applied to either of the springs, and thus one torsion spring may be easily damaged.

Also, as a pair of springs are provided, the width of the first slide member 130 and the second slide member 140 needs to be at least 25 mm. This hinders manufacturing of a slim mobile communication terminal.

Meanwhile, in FIG. 5, a different type of slide apparatus from that of FIG. 2 is illustrated. In detail, the slide apparatus of FIG. 5 includes a first slide member 130, a second slide member 140, and a pogo pin 150 that provides elastic force to the slide member 140 when the second slide member 140 slides toward the first slide member 130.

As the configuration of the first slide member 130 and the second slide member 140 is similar to the slide apparatus of the previously described embodiment, the description hereinafter will focus on the pogo pin 150.

As described in FIGS. 6 and 7, the pogo pin 150 includes a first supporting pipe 151 in which a spring 153 is mounted, a second supporting pipe 154 in which a spring 156 is mounted, a first insertion rod 152 and a second insertion rod 155, which are inserted into an open end of each of the supporting pipes 153 and 154 and move in a horizontal direction, and a cover portion 157 surrounding the outer circumference of the first and second supporting pipes 151 and 154. The first and second supporting pipes 151 and 154 are hollow, and a first end thereof is opened and a second end thereof is closed. The first and second supporting pipes 151 and 154 have the same configuration and are disposed in opposite directions. That is, the second end of the second supporting pipe 154 is disposed in the same direction as the first end of the first supporting pipe 151. Also, the first supporting pipe 151 and the second supporting pipe 154 are alternately arranged. Also, the pogo pin 150 further includes cap portions 158 and 159 mounted to the exposed end portions of each of the insertion rods 152 and 155. An external force is applied to the pogo pin 150 through the cap portions 158 and 159, and the cap portions 158 and 159 are fixed to adjacent insertion rods so that the insertion rods move in the same direction move at the same time. That is, as the first cap portion 158 holds the ends of the adjacent first insertion rods 152, when force is applied from the outside, the first insertion rods 152 can be moved identically. In the same way, the second cap portion 159 holds the ends of the second insertion rods 155, and thus the second insertion rods can be moved simultaneously and identically according to the external force.

The pogo pin 150 according to the current embodiment of the present invention operates as follows.

First, when forces in opposite directions, that is, forces that oppose each other, are applied to the first cap portion 158 and the second cap portion 159, the first insertions rods 152 and the second insertion rods 155 are inserted into the supporting pipes 151 and 154. As an end of the insertion rods inserted into the supporting pipes and the springs 153 and 156 inside the supporting pipes closely adhere to each other, the springs are compressed according to the force inserted into the insertion rods. Accordingly, the length of the pogo pin 150 is reduced. Then, when the force from the outside is removed, the insertion rods 152 and 155 are pulled to the outside by the restoring force of the springs 153 and 156, and thus the insertion rods are pulled along with the supporting pipes. Thus, the length of the pogo pin 150 is extended to be the previous length.

In the slide apparatus according to the conventional art, the first and second insertion rods 152 and 155 need to have a predetermined length or greater in order that the first and second insertion rods 152 and 155 are not withdrawn while the first and second supporting pipes 151 and 154 are being inserted into the cover portion 157, and thus it is difficult to reduce the width of the first slide member 130 and the second slide member 140 to be less than a predetermined width. Accordingly, a compact mobile communication terminal including the slide apparatus cannot be manufactured.

### DETAILED DESCRIPTION OF THE INVENTION

### Technical Problem

The present invention provides a slide apparatus of a mobile communication terminal, which can be easily assembled, can secure reliability of the entire mobile communication terminal, and can reduce the size of the entire mobile communication terminal.

### Technical Solution

According to an aspect of the present invention, there is provided a slide apparatus of a mobile communication terminal comprising: a first slide member fixed on a lower body of a mobile communication terminal; a second slide member that is fixed on an upper body of the mobile communication terminal and slideably coupled to the first slide member; and a torsion assembly providing torsion to the second slide member when the second slide member slides toward the first slide member, wherein the torsion assembly comprises: a first spring that is formed of a first coil that is wound in a circle and a first extension portion extending from a first end of the first coil, and is disposed between the first slide member and the second slide member, wherein an end of the first extension portion is coupled to the second slide member; a second spring that is formed of a second coil that is wound in a circle and stacked above or below the first coil and a second extension portion extending from a first end of the second coil, and is disposed between the first slide member and the second slide member, wherein an end of the second extension portion is coupled to the first slide member; and a coupling member coupling second ends of the first coil and the second coil.

### DESCRIPTION OF THE DRAWINGS

FIG. 1 is a perspective view of a typical slide type mobile communication terminal;

FIG. 2 is a plane view of a slide apparatus according to a conventional art;

FIGS. 3 and 4 show the operation of the slide apparatus of FIG_2;

FIG. 5 illustrates another slide apparatus according to a conventional art;

FIGS. 6 and 7 illustrate a pogo pin illustrated in FIG. 5;

FIG. 8 is a separate perspective view of a torsion assembly of a slide apparatus 5 according to an embodiment of the present invention;

FIG. 9 is a perspective view of the coupled torsion assembly illustrated in FIG. 8;

FIG. 10 is a cross-sectional view of a portion of the torsion assembly of FIG. 8 cut along a line VI-VI;

FIG. 11 is a plane view of a slide apparatus including the torsion assembly of FIG. 8;

FIGS. 12 and 13 illustrate the operation of the slide apparatus of FIG. 11;

FIG. 14 is a perspective view showing a coupled torsion assembly of a slide apparatus according to another embodiment of the present invention;

FIG. 15 is a separate perspective view showing a torsion assembly of a slide apparatus according to another embodiment of the present invention;

FIG. 16 is a cross-sectional view illustrating a portion of the torsion assembly cut along a line X 111-X III;

FIG. 17 is a cross-sectional view illustrating a portion of the torsion assembly cut along a line X IV-X Dl; and

FIG. 18 is a perspective view illustrating the coupled torsion assembly of FIG. 15.

### BEST MODE

The present invention will now be described more fully with reference to the accompanying drawings, in which exemplary embodiments of the invention are shown.

The slide apparatus of the mobile communication terminal according to the current embodiment of the present invention includes a first slide member 40, a second slide member 50, and a torsion assembly 60.

Referring to FIG. 11, the first slide member 40 is fixed on a lower body 110 and has a tetragonal plane. (in FIGS. 11, 110 and 100 not shown)

The second slide member 50 is fixed on an upper body 100 and is slideably coupled to the first slide member 40. To couple the second slide member 50 and the first slide member 40, a long hole 51 and connection pins 52 are provided.

The long hole 51 is a hole formed to be long in one direction along the edge of the second slide member, and a pair of long holes are provided. A first end of the connection pin 52 is fixedly coupled to the first slide member 40 and a second end of the connection pin 52 is formed through the long hole 51 and hooked on a rear surface of the second slide member 50. As the connection pin 52 slideably moves along in the long hole 51, the second slide member 50 can be slideably moved with respect to the first slide member 40.

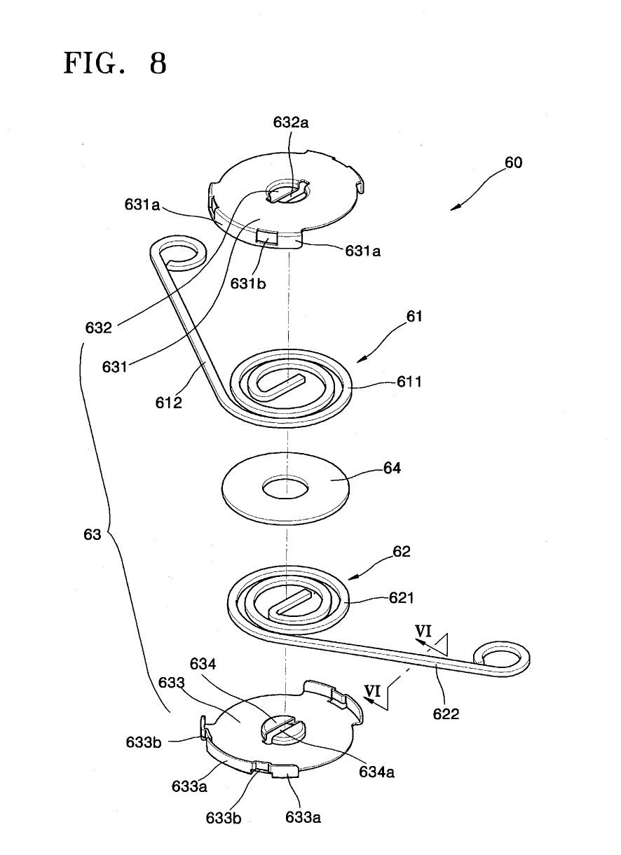

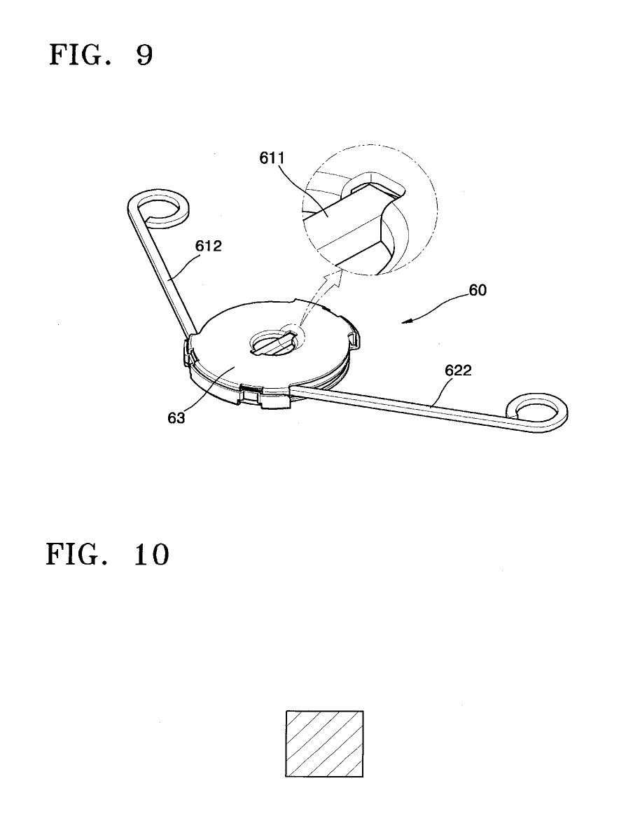

Referring to FIG. 8, the torsion assembly 60 includes a first spring 61, a second spring 62, a coupling member 63, and a separation plate 64.

The first spring 61 is disposed between the first slide member 40 and the second slide member 50, and a element wire of the first spring 61 has a tetragonal cross-section. The first spring 61 is formed of a first coil 611 and a first_extension portion 612.

The first coil 611 is wound in a circle, and a first end thereof is exposed to the outside and a second end thereof is in the center of the circle. The first extension portion 612 is extended from the first end of the first coil 611. The end of the first extension portion 612 is rotatably coupled to the second slide member 50.

The second spring 62 is disposed between the first slide member 40 and the second slide member 50, and a element wire of the second spring 62 has a tetragonal cross-section. The second spring 62 is formed of a second coil 621 and a second extension portion 622.

The second coil 621 is wound in a circle, and a first end thereof is exposed to the outside and a second end thereof is in the center of the circle. The second coil 621 and the first coil 611 are stacked above and below one another; in the current embodiment, the second coil 621 is disposed below the first coil 611. The second extension portion 622 is extended from the first end of the second coil 621, and an end of the second extension portion 622 is coupled to the first slide member 40. Meanwhile, the first spring 61 and the second spring 62 may preferably be rolling springs.

The coupling member 63 couples the second ends of the first coil 611 and the second coil 621 in order to fix their positions. As the second ends of the first coil 611 and the second coil 621 are fixed using the coupling member 63, the first coil 611 and the second coil 621 can be operated as one single torsion assembly 60. The coupling member 63 includes a first cover plate 631, a first supporting protrusion 632, a second cover plate 633, and a second supporting protrusion 634.

The first cover plate 631 covers a surface of the first coil 611, which does not face the second coil 621. The first cover plate 631 is a circular plate, and bent surfaces 631a, which are bent at a right angle, are formed on the outer circumference of the first cover plate 631. In the bent surfaces, opened hook receiving portions 631 b are formed.

The first supporting protrusion 632 protrudes from the center of the first cover plate 631 in a downward direction and is coupled to the second end of the first coil 611. A first slot 632a, which accommodates the second end of the first coil, is formed in a portion of the first supporting protrusion 632 that is coupled to the second end of the first coil 611.

The second cover plate 633 covers a surface of the second coil 621, which does not face the first coil 611. The second cover plate 633 has a shape corresponding to the first cover plate 631, and is a circular plate. In the outer circumference of the second cover plate 633, bent surfaces 633a which are bent at a right angle are formed. In the bent surfaces 633a, hook protrusions 633b that protrude toward a center portion of the second cover plate 633 are formed. As the hook protrusions 633b are hooked on the hook receiving portion 631 b, the second cover plate 633 is fixed on the first cover plate 631. Meanwhile, as the hook protrusions 633b are released from the hook receiving portion 631 b, the fixation of the second cover plate 633 on the first cover plate 631 is released.

The second supporting protrusion 634 protrudes from the center portion of the second cover plate 633 and is coupled to the second end of the second coil 621. A second slot 634a that accommodates the second end of the second coil 621 is formed in a portion of the second supporting protrusion 634 that is coupled to the second coil 621.

The separation plate 64 is a circular plate having an opened center portion, and is disposed between the first coil 611 and the second coil 621. The outer diameter of the separation plate 64 is approximately the same as the outer diameter of the first coil 611 or the second coil 621.

The above-described torsion assembly 60 can be assembled in the following manner. As the first spring 61, the separation plate 64, and the second spring 62 are inserted between the first cover plate 631 and the second cover plate 633, the first cover plate 631 and the second cover plate 633 are fixed. Here, in order to fix the first cover plate 631 and the second cover plate 633, the hook receiving portion 631 b of the first cover plate 631 is hooked on the hook protrusion 633b of the second cover plate 633.

Meanwhile, the first spring 61 allows the second end of the first coil 611 of the first spring 61 to be inserted into and coupled to the first slot 632a of the first supporting protrusion 632 of the first cover plate 631. Also, the second spring 62 allows the second end of the second coil 621 of the second spring 62 to be inserted into and coupled to the second slot 634a of the second supporting protrusion 634 of the second cover plate 633, and the separation plate 64 is inserted between the first spring 61 and the second spring 62. The separation plate 64 is inserted in order to prevent interference between the first coil 611 and the second coil 621 when they are winding or unwinding. Meanwhile, the torsion assembly 60 is assembled separately in a separate spring manufacturing process apart from the assembly line of the mobile communication terminal.

The slide apparatus of the mobile communication terminal according to the current embodiment of the present invention operates as follows.

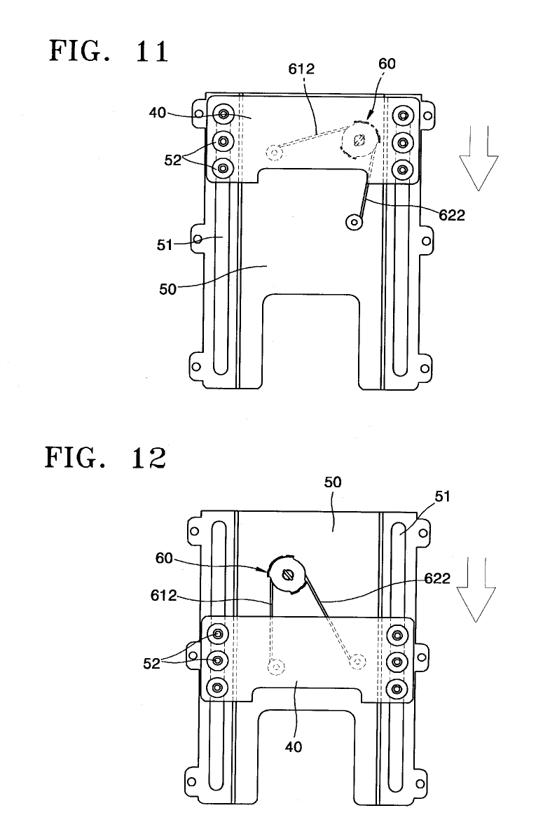

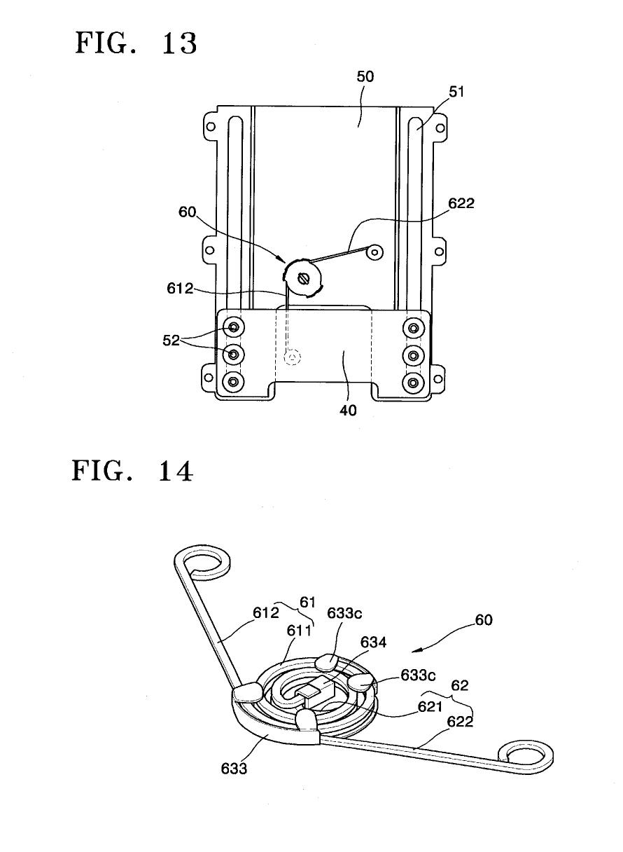

In FIG. 11, the torsion assembly 60 is coupled to the first slide member 40 and the second slide member 50. As the second slide member 50 is moved in one direction toward the first slide member 40, a distance between the first extension portion 612 and the second extension portion 622 is gradually reduced, and thus increased torsion is provided to the second slide member 50. As shown in FIG. 12, when the second slide member 50 has moved half of the movement distance and the distance between the first extension portion 612 and the second extension portion 622 is reduced as much as possible, maximum torsion is provided to the second slide member 50. When the second slide member 50 is moved a little bit to one side in this state, it is moved to a side without any external force due to the torsion which tends to increase the distance between the first extension portion 612 and the second extension portion 622. In FIG. 13, the second slide member 50 is moved as much as possible to one side. Meanwhile, the same operation as described above is also repeated when the second slide member 50 is moved in the opposite direction.

The slide apparatus of the mobile communication terminal according to the current embodiment of the present invention has the following advantages.

First, the slide apparatus according to the current embodiment of the present invention can be easily manufactured. That is, the torsion assembly of a conventional slide apparatus requires a relatively long assembly time for a pair of springs to be coupled respectively to the first slide member and the second slide member.

In contrast, according to the current embodiment of the present invention, just one assembly needs to be coupled to the first and second slide members, and thus the assembly time can be reduced. In particular, since two coils, first and second coils, are provided in one assembly, the total torsion does not decrease.

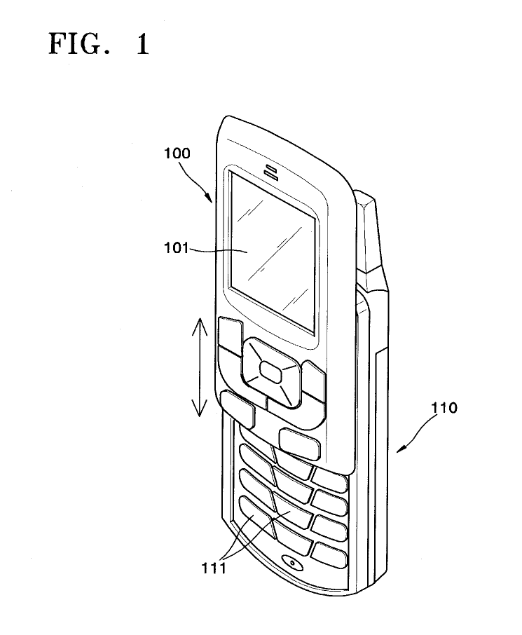

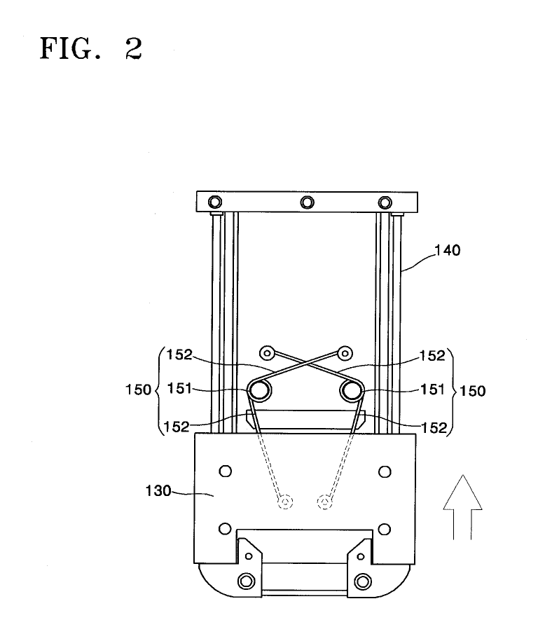

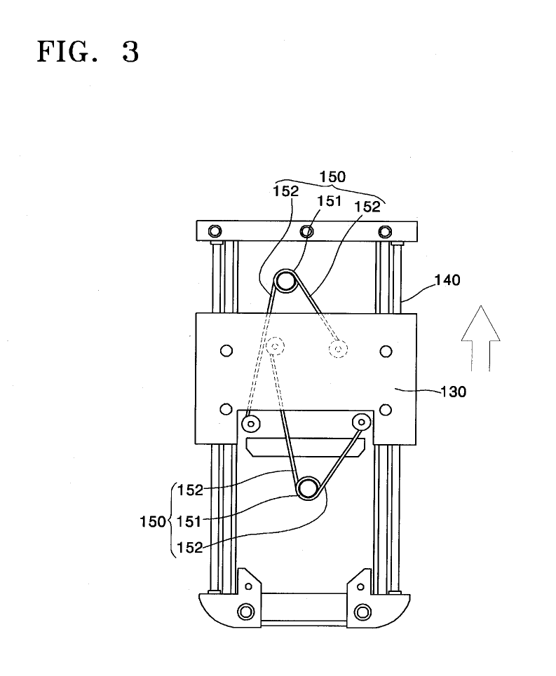

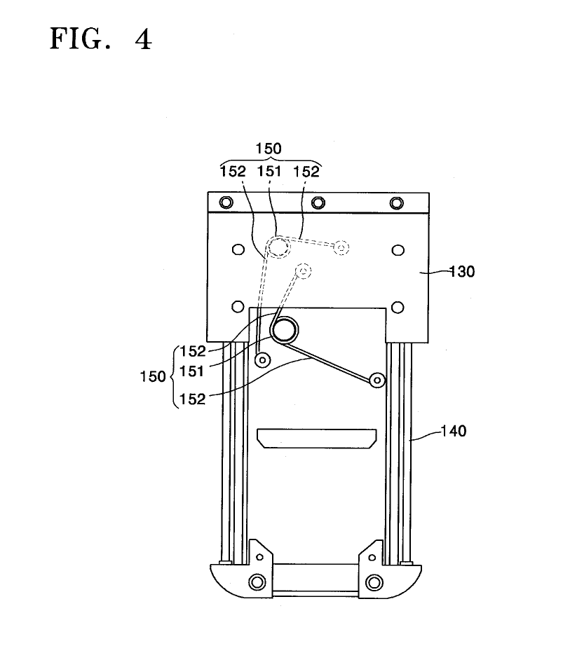

Also, as identical torsion is applied to the one pair of springs that are stacked above and below one another in the slide apparatus of the current embodiment of the present invention, identical durability can be ensured for each of the springs and the reliability of the entire mobile communication terminal can be increased. In the conventional slide apparatus shown in FIG. 1, it is difficult to install the one pair of springs symmetrically, and even when the springs are symmetrically installed, it is difficult to maintain identical torsion.

Accordingly, identical torsion to each of the springs is hard to achieve in the conventional slide apparatus. However, according to the current embodiment of the present invention, identical torsion is applied to the first and second springs that are stacked above and below one another.

In addition, according to the current embodiment of the present invention, the tetragonal cross-section of the element wire of the springs can contribute to making the slide apparatus slim.

When the cross-section of the element wire is circular, the diameter needs to be 1.0 mm, in general; however, in the case of a tetragonal cross-section, the height can be reduced to 0.7 mm. This is because torsion can be maintained the same by reducing the height and increasing the width. Accordingly, by using a tetragonal cross-section with a reduced height instead of a circular cross-section in this embodiment, the height of the total torsion assembly can be reduced.

Also, in the current embodiment of the present invention, since one spring is used, a width needed for the operation of the spring can be reduced. Accordingly, a compact slide apparatus can be manufactured and hence the whole mobile communication terminal can be manufactured to be slim. In contrast, the conventional slide apparatus illustrated in FIG. 1 includes two springs and thus a space for the two springs to operate at the same time is required. Thus a compact slide apparatus cannot be conventionally manufactured.

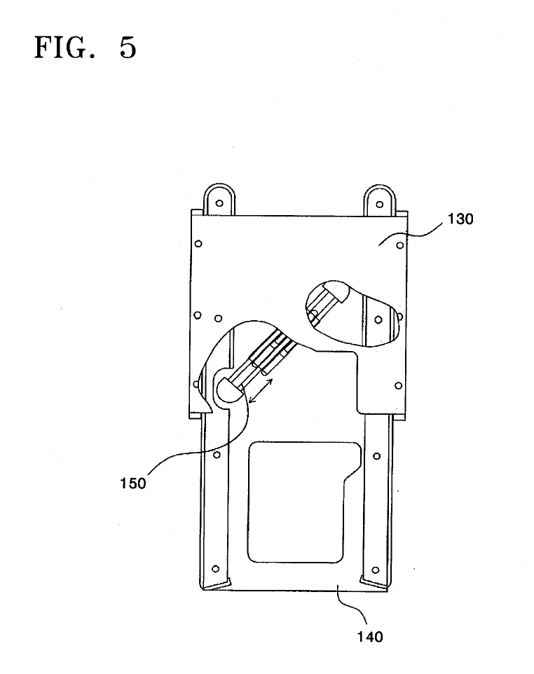

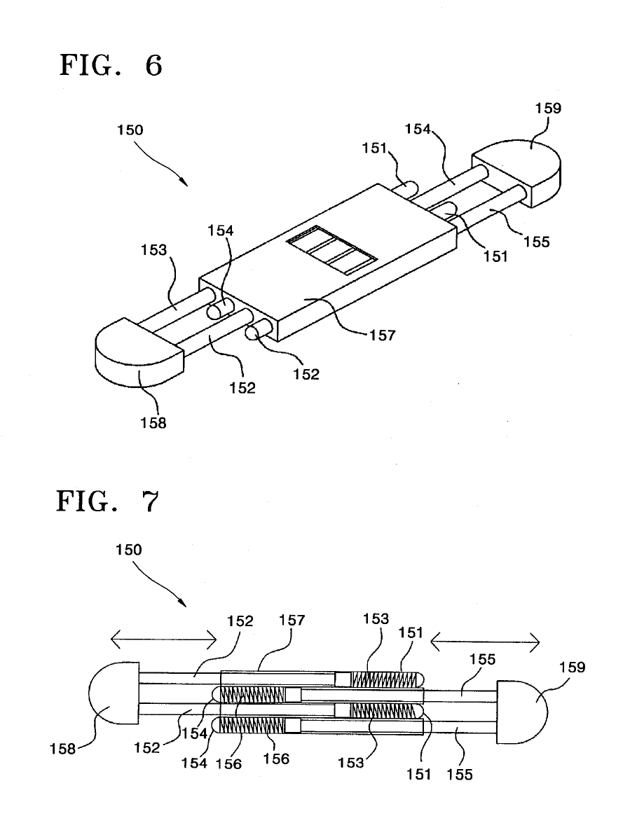

In addition, it is not difficult to reduce the width of the whole slide apparatus according to the current embodiment to a predetermined width or less. However, in the case of the conventional slide apparatus illustrated in FIG. 5, it is difficult to reduce the lengths of the first supporting pipe 151, the second supporting pipe 154, the first insertion rod 152, and the second insertion rod 155 to a certain length or less, and the width of the first slide member 130 and the second slide member 140 is also difficult to reduce to a certain width or less.

The slide apparatus of the mobile communication terminal according to the current embodiment of the present invention can be modified as follows.

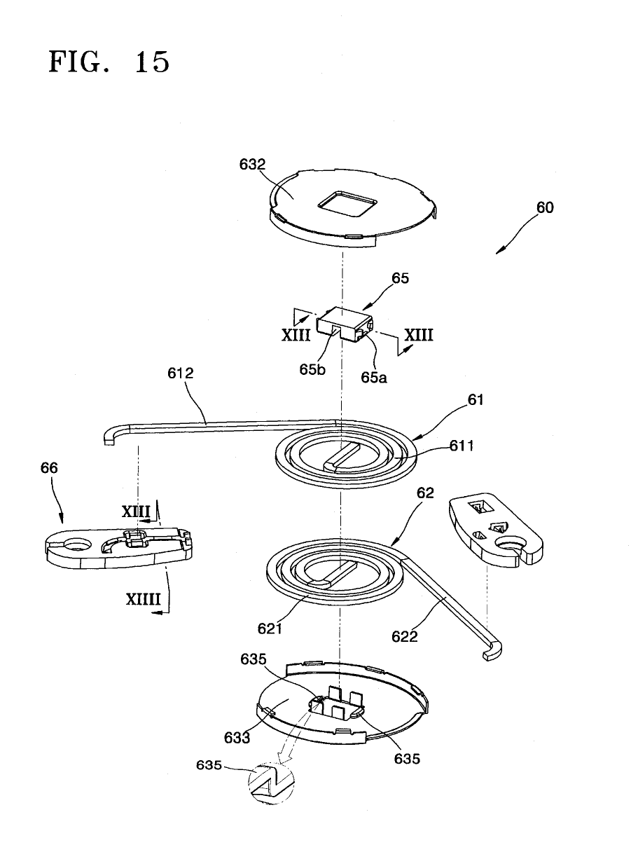

As shown in FIG. 14, while the first cover plate 631 shown in FIG. 8 is being removed, the second ends of the first coil 611 and the second coil 621 may be coupled together in the second supporting protrusion 634 provided in the second cover plate 633. The first spring 61 and the second spring 62 are fixed by hook pieces 633c provided around the second cover plate 633 as illustrated in FIG. 11. Also, any configuration in which the second ends of the first coil 611 and the second coil 612 are coupled may be used. In addition, while a tetragonal cross-section of the element wire is illustrated in the above-described embodiment, other polygonal cross-sections other than a circular cross-section may also be used.

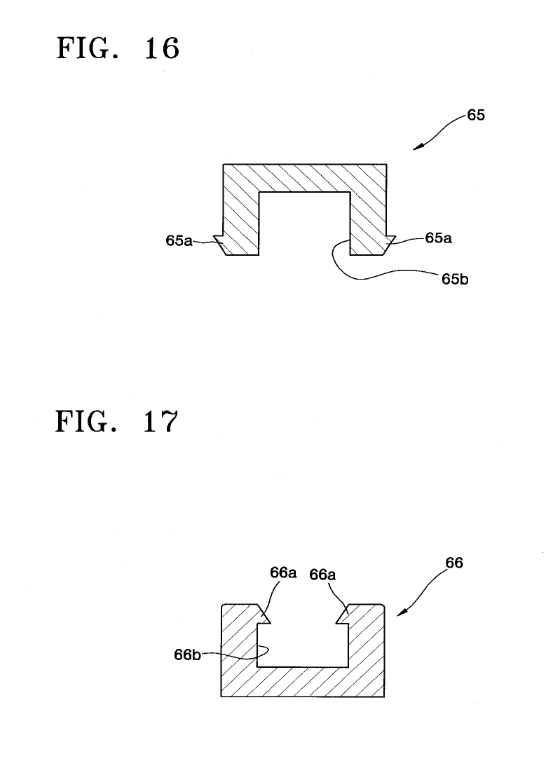

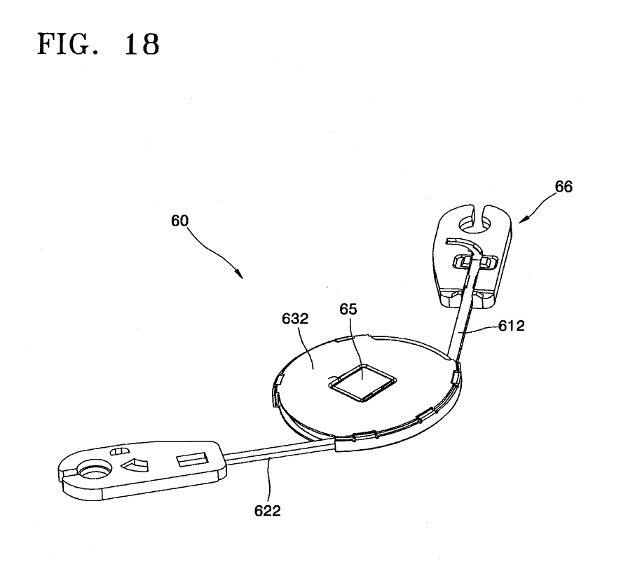

Also, as illustrated in FIGS. 15 through 18, a fixation piece 65, through which the other ends of the first coil 611 and the second coil 621 are coupled to each other, is manufactured separately from the second cover plate 633 and coupled to the second cover plate 633. Also, clip members 66 and 67 are formed to improve the assembly characteristics of both ends of the first and second extension portions 612 and 622 at the ends of the first and second extension portions 612 and 622, respectively.

In detail, a tetragonal through hole is formed in the center of the first cover plate 632, and this through hole has a size capable of accommodating the fixation piece 65.

The fixation piece 65 is parallelopipedonal, and a fixation piece slot 65b that is hollowed upward and has a size capable of accommodating the second coil 621 and the second coil 621 is formed on a rear surface of the fixation piece 65. Also, a fixation piece hook receiving portion 65a that protrudes from a side of the fixation piece 65 and is formed at the side of the fixation piece 65.

A tetragonal through hole having a size corresponding to the fixation piece 65 is formed in a center portion of the second cover plate 633. In the edges of the through hole facing each other, cover plate hook protrusions 635 that protrude upward are formed. The cover plate hook protrusions 635 are formed in positions corresponding to the cover plate hook receiving portions 65a, having a shape capable of preventing the fixation piece 65 from detaching from the second cover plate 633 when the fixation piece 65 is coupled to the fixation piece hook receiving portion 65a.

The first clip member 66 is formed of a synthetic resin and accommodates an end of the first extension portion 612 and is rotatably coupled to the second slide member 50. A first accommodation groove 66b having a shape corresponding to the end of the first extension portion 612 is formed in the first clip member 66. A fixation protrusion 66a protruded inward is formed on inner walls of the first accommodation groove 66b. The fixation piece 66a allows the end of the first extension portion 612 to be accommodated inside, and once the first extension portion 612 is inserted into the accommodation groove 66b, the fixation piece 66a prevents the first extension portion 612 from detaching from the first clip member 66. Meanwhile, a metal clip may be further formed in the accommodation groove 66b of the first clip member 66, to reinforce the coupling of the first clip member 66 to the first extension portion 612. Fixation protrusions that protrude inward like the above-described fixation protrusion are also formed in the metal clip, preventing the first extension portion from detachment, once the first extension portion is accommodated inside the fixation protrusion.

The metal clip is formed inside the first clip member 66 by using an insertion injection process. Meanwhile, a second clip member having a similar shape as the first clip member is coupled to an end of the second extension portion 622. Here, a detailed description of the second clip member will be omitted.

In order to combine these components, first, the second spring 62 having the second coil 621 and the first spring 61 having the first coil 611 are sequentially stacked on the second cover plate 633. Then, the fixation piece 65 is coupled to the second cover plate 633. The second end of the first coil 611 and the second end of the second coil 621 are accommodated in the fixation piece slot 65b. Also, when the fixation piece 65 is coupled to the second cover plate 633, the cover plate hook protrusion 635 receives the fixation hook receiving portion 65a of the fixation piece 65, so that the fixation piece 65 does not detach from the second cover plate 633 once the fixation piece hook receiving portion 65a and the cover plate hook protrusion 633 are coupled to each other. Then, the first cover plate 631 is inserted into the second cover plate 633. Also, the first clip member 66 and the second dip member are coupled to the ends of the first and second extension portions 612 and 622.

When the fixation piece 65 is used as described above, the first and second springs 61 and 62 can be coupled to the second cover plate 612 by coupling the fixation piece hook receiving portion 65a and the cover plate hook protrusion 635 once, thereby simplifying the assembling process.

Also, the first clip member 66 can be easily inserted into the first extension portion 612 by inserting an end of the first extension portion 612 into a fixation protrusion of the first clip member 66, thereby simplifying the whole assembling process.

While the present invention has been particularly shown and described with reference to exemplary embodiments thereof, it will be understood by those of ordinary skill in the art that various changes in form and details may be made therein without departing from the spirit and scope of the present invention as defined by the following claims.

### ADVANTAGEOUS EFFECTS

As described above, a slide apparatus of the mobile communication terminal according to the present invention can be assembled with a reduced assembly time while ensuring reliability of the entire mobile communication terminal

1. A slide apparatus of a mobile communication terminal comprising:
a first slide member fixed on a lower body of a mobile communication terminal;
a second slide member that is fixed on an upper body of the mobile communication terminal and slideably coupled to the first slide member; and
a torsion assembly providing torsion to the second slide member when the second slide member slides toward the first slide member,
wherein the torsion assembly comprises:
a first spring that is formed of a first coil that is wound in a circle and a first extension portion extending from a first end of the first coil, and is disposed between the first slide member and the second slide member, wherein an end of the first extension portion is coupled to the second slide member;
a second spring that is formed of a second coil that is wound in a circle and stacked above or below the first coil and a second extension portion extending from a first end of the second coil, and is disposed between the first slide member and the second slide member, wherein an end of the second extension portion is coupled to the first slide member; and
a coupling member coupling second ends of the first coil and the second coil.

2. The slide apparatus of claim 1, wherein an element wire of the first spring and the second spring have a tetragonal cross-section.

3. The slide apparatus of claim 1, wherein the coupling member comprises:
a first cover plate covering a surface of the first coil, which does not face the second coil;
a first supporting protrusion protruding from the first cover plate and being coupled to the second end of the first coil;
a second cover plate covering a surface of the second coil, which does not face the first coil, and being inserted and fixed to the first cover plate; and
a second supporting protrusion protruding from the second cover plate and being coupled to the second end of the second coil.

4. The slide apparatus of claim 3, wherein a first slot to which the second end of the first coil is inserted and fixed is formed in the first supporting protrusion,
and a second slot to which the second end of the second coil is inserted and fixed is formed in the second supporting protrusion.

5. The slide apparatus of claim 3, wherein a hook receiving portion is formed in the first cover plate,
and a hook protrusion that is formed in a corresponding position to the hook receiving portion and allows the second cover plate to be fixed on the first cover plate when the hook protrusion is hooked on the hook receiving portion is formed in the second cover plate.

6. The slide apparatus of claim 1, wherein the coupling member comprises:
a second cover plate covering a surface of the second coil, which does not face the first coil, and being fixed to the first cover plate; and
a supporting protrusion protruding from the second cover plate and being coupled to the second ends of the first and second coils to fix the first and second coils.

7. The slide apparatus of claim 6, wherein a hook piece contacting a surface of the first coil, which does not face the second coil, and fixing the first and second coils, is formed on the second cover plate.

8. The slide apparatus of claim 1, wherein the coupling member comprises:
a second cover plate covering a surface of the second coil, which does not face the first coil; and
a fixation piece fixing the second ends of the first and second coils and being provided in the second cover plate.

9. The slide apparatus of claim 8, wherein a first cover plate that is coupled to the second cover plate and covers a surface of the first coil, which does not face the second coil, is formed in the coupling member.

10. The slide apparatus of claim 8, wherein the fixation piece comprises:
a fixation piece hook receiving portion; and
a cover plate hook protrusion that is formed in a corresponding position to the fixation hook receiving portion and prevents the fixation piece from detaching from the second cover plate when the cover plate hook protrusion is coupled to the fixation piece hook receiving portion.

11. The slide apparatus of claim 8, wherein slot accommodating the second ends of the first and second coils is formed in the fixation piece.

12. The slide apparatus of claim 1, wherein a first clip member is further formed at an end of the first extension portion, which accommodates the end of the first extension portion so as to be attachable and detachable and is rotatably coupled to the second slide member.

13. The slide apparatus of claim 12, wherein a first accommodation groove having a shape corresponding to the end of the first extension portion is formed in the first clip member, and a first extension hook protrusion that allows the end of the first extension portion to be accommodated but prevents the end of the first extension portion from detaching, is formed on inner walls of the first accommodation groove.
